(19) United States
(12) Patent Application Publication
(10) Pub. No.: US 2005/0073703 A1
(43) Pub. Date: Apr. 7, 2005

(54) Image processing device and method for performing gamma correction

(75) Inventor: Naomi Nakane, Kanagawa-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/679,340

(22) Filed: Oct. 7, 2003

(51) Int. Cl. H04N 1/40; H04N 1/48; H04N 1/56; H04N 1/04

(52) U.S. Cl. 358/1.9; 358/519; 358/504; 358/505; 358/506; 358/406; 358/474

(57) ABSTRACT

An image forming device and method is provided, the device including a scanner configured to scan an image pattern, and a processor. The processor is configured to color scan the image pattern in a first direction and monochrome scan the image pattern in a second direction different from the first direction. The processor calculates a color gamma correction pattern based on the color scan of the image pattern, and calculates a monochrome gamma correction pattern based on the monochrome scan of the image pattern. The processor adjusts the scanner based on the calculated color and monochrome gamma correction patterns for the image pattern.

### BACKGROUND OF THE INVENTION

A. Field of the Invention

The invention relates generally to image processing devices such as photocopiers, facsimile machines, scanners, and printers, and, more particularly, to a method and apparatus for performing gamma correction in an image forming device.

B. Background of the Invention

Photocopiers, facsimile machines, scanners and printers for imaging an item on a media are known. These devices may include a charge couple device (CCD) for generating an electrical signal by scanning the item, as is done by many conventional photocopiers. The electrical signal generated by CCDs, however, is not always linearly proportional to the light intensity that it reads. Similarly, when the generated electrical signal is used to image a “copy” of the item on a media with an image formation unit, the applied toner or ink is not always linearly proportional to the electrical signal sent to the image formation unit. This disproportion is generally referred to as gamma distortion. Techniques have been proposed for performing gamma correction in image forming devices.

One such technique for performing gamma correction involves scanning a test image pattern with a color CCD, and calculating a black and white (B/W) gamma correction pattern and a color gamma correction pattern from the color scan. The gamma correction patterns are then used to “weigh” the electrical signal generated by the CCD and/or sent to the image formation unit, thereby compensating for the gamma distortion. By calculating the B/W gamma correction pattern from the color scan rather than performing a separate B/W scan, however, the B/W gamma correction pattern varies slightly from the actual B/W signal. Thus, even as corrected, inevitably, some distortion with exist in the actual B/W signal using these types of gamma correction techniques.

### SUMMARY OF THE INVENTION

According to one embodiment of the present invention, a method for performing gamma correction in an image forming device is provided including the steps of first scanning an image pattern in a first direction, second scanning the image pattern in a second direction different from the first direction, calculating a first gamma correction pattern based on the first scan of the image pattern, calculating a second gamma correction pattern based on the second scan of the image pattern, and adjusting a scanning process in the image forming device based on the calculated first and second gamma correction patterns for the image pattern.

According to another embodiment of the present invention, an image forming device is provided including a scanner configured to scan an image pattern, and a processor. The processor is configured to color scan the image pattern in a first direction, monochrome scan the image pattern in a second direction different from the first direction, calculate a color gamma correction pattern based on the color scan of the image pattern, calculate a monochrome gamma correction pattern based on the monochrome scan of the image pattern, and adjust the scanner based on the calculated color and monochrome gamma correction patterns for the image pattern.

According to another embodiment of the present invention, an image forming device is provided including means for color scanning an image pattern in a first direction, means for monochrome scanning the image pattern in a second direction different from the first direction, means for calculating a color gamma correction pattern based on the color scan of the image pattern, means for calculating a monochrome gamma correction pattern based on the monochrome scan of the image pattern, and means for adjusting a scanning process in the image forming device based on the calculated color and monochrome gamma correction patterns for the image pattern.

Further features, aspects and advantages of the present invention will become apparent from the detailed description of preferred embodiments that follows, when considered together with the accompanying drawing figures.

### BRIEF DESCRIPTION OF THE DRAWINGS

FIG. 1 is a block diagram of an image forming device according to an embodiment of the present invention.

FIG. 2 is a block diagram of a four channel charge couple device (CCD) according to an embodiment of the present invention.

FIG. 3 is a block diagram of a test image pattern according to an embodiment of the present invention.

FIG. 4 is a flowchart of a method for performing gamma correction in an image forming device according to an embodiment of the present invention.

FIG. 5 is a flowchart of a method of calculating a gamma correction pattern based on a scan according to an embodiment of the present invention.

FIG. 6 is a flowchart of a method for verifying gamma correction in an image forming device according to an embodiment of the present invention.

FIG. 7 is a chart depicting gamma distortion according to an embodiment of the present invention.

### DETAILED DESCRIPTION OF EXEMPLARY EMBODIMENTS

Reference will now be made in detail to presently preferred embodiments of the invention. Wherever possible, the same reference numbers will be used throughout the drawings to refer to the same or like parts.

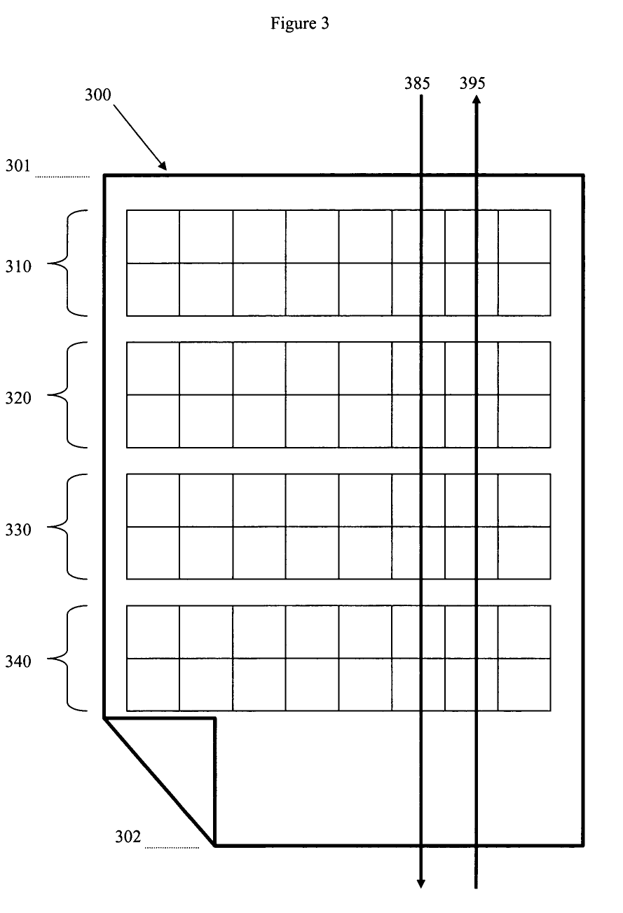

FIG. 1 shows a block diagram of an image forming device 100 according to one embodiment of the present invention. The image forming device 100 includes a scanner 130 configured to scan an image pattern 300 (such as that shown in FIG. 3), an image formation unit 110 configured to form an image on a media before or after the scanner 130 is adjusted, and a processor 120 electrically coupled to image formation unit 110 and scanner 130 to control one or both of image formation unit 110 and scanner 130. Other components are normally provided in the image forming device, as known and would be readily apparent to one of ordinary skill in the art based on the present disclosure.

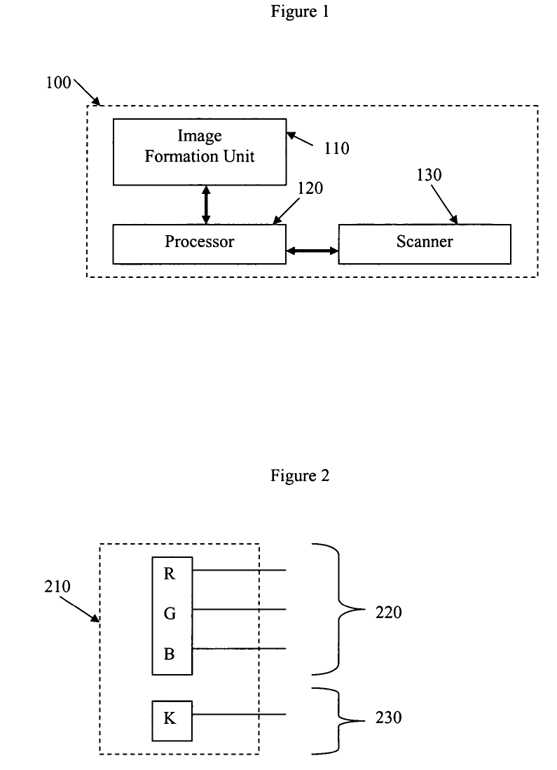

As shown in FIG. 2, the scanner 130 may include a charge couple device (CCD) 210, such as a four channel (R,G,B,K) CCD. CCD 210 preferably includes at least a three channel color output 220 including a red channel (R), a green channel (G), and a blue channel (B), and a single channel monochrome output 230 (K). CCD 210 may output on all four channels (R,G,B,K) simultaneously, or may switch (or be switched) from a three channel color output 220 to a single channel monochrome output 230, depending on the particular implementation desired. Other configurations for CCD 210 (e.g. a larger number of channels) are also contemplated.

Gamma correction for the image forming device 100 is performed by scanning and processing a test image pattern, such as the test image pattern 300 shown in FIG. 3. Exemplary test image pattern 300 may be provided with four (or more or less) test sections 310, 320, 330 and 340 as shown. According to one embodiment of the present invention, section 310 is a black and white (B/W) section, and sections 320, 330 and 340 are color sections. By way of example, section 320 may be a red section, section 330 may be a green section, and section 340 may be a blue section. As would be readily apparent to one of ordinary skill in the art after reading this disclosure, the square portions in each of sections 310, 320, 330 and 340 preferably represent different shading of the particular test color/monochrome section as commonly provided for gamma correction. Other test image patterns may also be used instead of test image pattern 300, and are within the scope of the embodiments of the present invention. The image pattern 300 can be generated in many ways and take on various forms. In this regard, the image pattern may be printed by the image forming device for use in the gamma correction process.

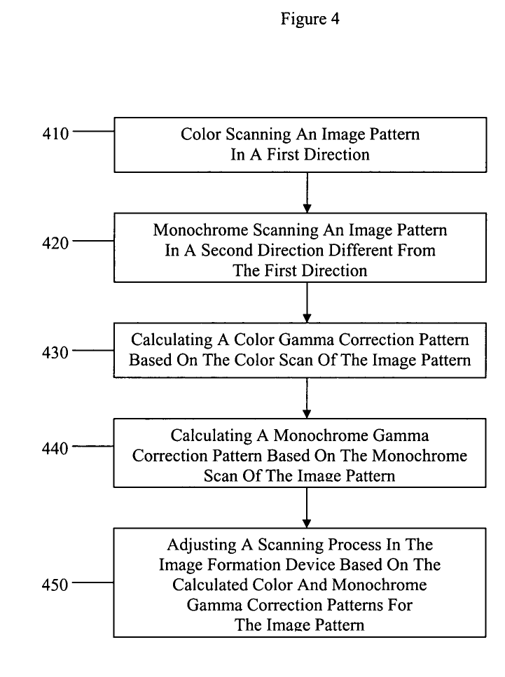

A method for performing gamma correction in the image forming device 100 of FIG. 1 will now be described in reference to the flow chart of FIG. 4. In step 410, the scanner 130 color scans image pattern 300 in a first direction 385, preferably from a leading edge 301 to a trailing edge 302 of the image pattern. Scanner 130 may color scan image pattern 300 by using only color output 220 of CCD 210 (FIG. 2). In step 420, the scanner 130 monochrome scans image pattern 300 in a second direction 395, preferably from the trailing edge 302 to the leading edge 301 thereof. Similarly, scanner 130 may monochrome scan image pattern 300 by using only monochrome output 230 of CCD 210 (FIG. 2). Preferably, both step 410 and step 420 are performed in a single periodic pass over image pattern 300, the single periodic pass including “forward” scanning the image pattern 300 in direction 385, followed by “backward” scanning the image pattern 300 in direction 395. The CCD output may be switched from the color output 220 to the monochrome output 230 between the “forward” and “backward” scanning steps. However, a non-periodic part or multiple scans may also be used. It should further be appreciated that the particular order of steps 410 and 420 may be reversed from that shown in FIG. 4.

In step 430, processor 120 calculates a color gamma correction pattern based on the color scan of step 410. In step 440, processor 120 similarly calculates a monochrome gamma correction pattern based on the monochrome scan of step 420. In this regard, step 430 may be performed while scanner 130 monochrome scans image pattern 300 in step 420, while calculating the monochrome gamma correction pattern in step 440, or at another convenient time. In step 450, the scanning process is adjusted in the image forming device 100 based on the calculated color and monochrome gamma correction patterns for the image pattern of steps 430 and 440. In this manner, gamma correction is performed for image forming device 100.

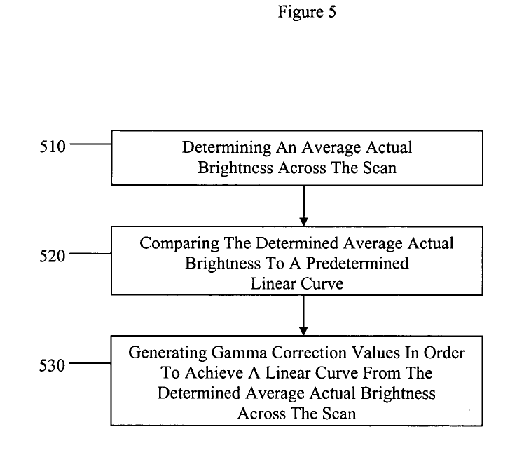

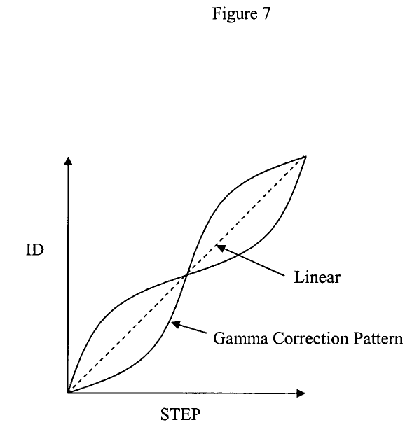

According to one embodiment of the present invention, one or both of steps 430 and 440 may be performed by the method shown in the flowchart of FIG. 5. In step 510, processor 120 determines an average actual brightness across the color and/or monochrome scan. In step 520, processor 120 then compares the determined average actual brightness to a predetermined linear curve (see FIG. 7). Based on this comparison, processor 120 generates gamma correction values in step 530 in order to achieve the linear curve from the determined average actual brightness across the color and/or monochrome scan. Other techniques for calculating the gamma correction patterns are also plausible, including those already known and any others that would be readily apparent to one of ordinary skill in the art after reading this disclosure.

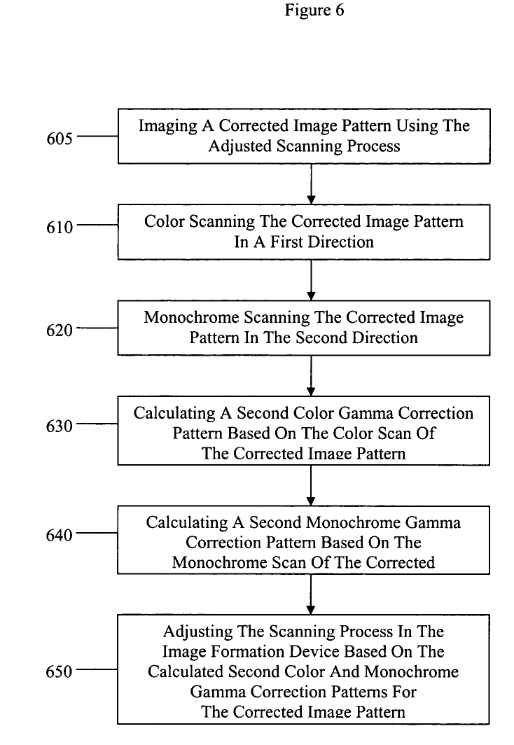

According to yet another embodiment of the present invention, once the scanning process has been adjusted in step 450 (FIG. 4), a verification process may be further employed to verify that a predetermined desired level or sufficient amount of gamma correction has taken place. FIG. 6 shows a flowchart of one exemplary verification process. More specifically, in step 605, image formation unit 110 may be used to image a corrected image pattern (which can be printed by the image forming device) using the adjusted scanning process (or the image pattern in 360 may be revised). In step 610, the scanner 130 color scans the corrected image pattern in the first direction 385. In step 620, the scanner 130 monochrome scans the corrected image pattern in the second direction 395. Scanning steps 610 and 630 are then used to calculate second gamma correction patterns in steps 630 and 640, respectively, which are then used to adjust the scanning process in step 650, if necessary. It should be appreciated that steps 610-650 may be performed in a manner analogous to that previously described with respect to steps 410-450, respectively of FIG. 4. In this manner, the accuracy of the gamma correction can be improved by implementing a verification process.

According to another variation of the embodiments of the present invention, the color gamma correction pattern and/or the monochrome gamma correction pattern may comprise discrete gamma correction patterns for photographs and text. Discrete gamma correction patterns for photographs and text may be particularly beneficial due to the different optical characteristics of photographic paper versus non-photographic paper, in addition to differing needs in scanning resolution, etc. Furthermore, the color gamma correction pattern may comprise discrete color gamma correction patterns for red, green, and blue colors in order to properly compensate for varying results specific to each of these three colors. Other configurations are also plausible as would be readily apparent to one of ordinary skill in the art after reading this disclosure.

By performing gamma correction by way of one or more of the above described embodiments, the residual distortion caused by calculating the monochrome gamma correction pattern using the color scan is avoided. Additionally, time delays caused by separate scans of the image pattern 300 also can be avoided by performing the monochrome scan and the color scan in a single periodic pass over the image pattern 300. Other advantages are also contemplated, as would be readily apparent to one of ordinary skill in the art after reading this disclosure.

The foregoing description of preferred embodiments of the invention has been presented for purposes of illustration and description. It is not intended to be exhaustive or to limit the invention to the precise form disclosed, and modifications and variations are possible in light in the above teachings or may be acquired from practice of the invention. The aspects of the embodiments may be combined with one another. The embodiments were chosen and described in order to explain the principles of the invention and a practical application to enable one skilled in the art to utilize the invention in various embodiments and with various modifications are suited to the particular use contemplated.

1. A method for performing gamma correction in an image forming device, comprising:
first scanning an image pattern in a first direction;
second scanning the image pattern in a second direction different from the first direction;
calculating a first gamma correction pattern based on the first scan of the image pattern;
calculating a second gamma correction pattern based on the second scan of the image pattern; and
adjusting a scanning process in the image forming device based on the calculated first and second gamma correction patterns for the image pattern.

2. The method of claim 1, wherein the first scan is a color scan and the second scan is a monochrome scan.

3. The method of claim 1, wherein the first direction is a forward direction and the second direction is a backward direction with respect to the image pattern.

4. The method of claim 3, wherein both first scanning and second scanning are performed in a single periodic pass over the image pattern, the single periodic pass including scanning the image pattern in the forward direction covering a leading end to a trailing end of the image pattern, and scanning the image pattern in the backward direction covering the trailing end to the leading end of the image pattern.

5. The method of claim 1, further comprising printing the image pattern using the image forming device.

6. The method of claim 1, further comprising switching a charge couple device (CCD) output from a color output to a monochrome output after the step of first scanning and before the step of second scanning.

7. The method of claim 1, wherein at least one of the step of calculating a first gamma correction pattern and the step of calculating a second gamma correction pattern comprises:
determining an average actual brightness across the scan;
comparing the determined average actual brightness to a predetermined linear curve; and
generating gamma correction values in order to achieve a linear curve from the determined average actual brightness across the scan.

8. The method of claim 1, wherein the step of calculating a first gamma correction pattern comprises calculating discrete color gamma correction patterns for at least red, green, and blue colors.

9. The method of claim 1, wherein the step of calculating a first gamma correction pattern comprises calculating discrete color gamma correction patterns for at least a photograph image pattern and a text image pattern.

10. The method of claim 1, wherein the step of calculating a second gamma correction pattern comprises calculating discrete monochrome gamma correction patterns for at least a photograph image pattern and a text image pattern.

11. The method of claim 1, further comprising:
obtaining a corrected image pattern using the adjusted scanning process;
color scanning the corrected image pattern in the first direction;
monochrome scanning the corrected image pattern in the second direction;
calculating a third gamma correction pattern based on the color scan of the corrected image pattern;
calculating a fourth gamma correction pattern based on the monochrome scan of the corrected image pattern; and
adjusting the scanning process on the image forming device based on the calculated third and fourth gamma correction patterns for the corrected image pattern.

12. The method of claim 1, wherein the step of first scanning an image pattern comprises color scanning the image pattern with a charge couple device (CCD) output set at a full color output.

13. The method of claim 1, wherein the step of second scanning the image pattern comprises monochrome scanning the image pattern with a charge couple device (CCD) output set at a black and white (B/W) output.

14. An image forming device, comprising:
a scanner configured to scan an image pattern; and
a processor configured to:
color scan the image pattern in a first direction;
monochrome scan the image pattern in a second direction different from the first direction;
calculate a color gamma correction pattern based on the color scan of the image pattern;
calculate a monochrome gamma correction pattern based on the monochrome scan of the image pattern; and
adjust the scanner based on the calculated color and monochrome gamma correction patterns for the image pattern.

15. The image forming device of claim 14, wherein the scanner includes a four channel charge couple device (CCD).

16. The image forming device of claim 14, further comprising an image formation unit configured to form a corrected image pattern using the scanner as adjusted by the processor.

17. The image forming device of claim 16, wherein the processor is further programmed to:
color scan the corrected image pattern in the first direction;
monochrome scan the corrected image pattern in the second direction;
calculate a second color gamma correction pattern based on the color scan of the corrected image pattern;
calculate a second monochrome gamma correction pattern based on the monochrome scan of the corrected image pattern; and
adjust the scanner based on the calculated second color and monochrome gamma correction patterns for the corrected image pattern.

18. The image forming device of claim 14, wherein the processor is configured to perform both the color scanning and the monochrome scanning in a single periodic pass over the image pattern, the single periodic pass including scanning the image pattern in the forward direction covering a leading end to a trailing end of the image pattern, and scanning the image pattern in the backward direction covering the trailing end to the leading end of the image pattern.

19. An image forming device, comprising:
means for color scanning an image pattern in a first direction;
means for monochrome scanning the image pattern in a second direction different from the first direction;
means for calculating a color gamma correction pattern based on the color scan of the image pattern;
means for calculating a monochrome gamma correction pattern based on the monochrome scan of the image pattern; and
means for adjusting a scanning process in the image forming device based on the calculated color and monochrome gamma correction patterns for the image pattern.

20. The image forming device of claim 19, wherein the means for color scanning and the means for monochrome scanning perform the scanning in a single periodic pass over the image pattern, the single periodic pass including scanning the image pattern in a forward direction covering a leading end to a trailing end of the image pattern, and scanning the image pattern in a backward direction covering the trailing end to the leading end of the image pattern.
